(19) United States
(12) Patent Application Publication
(10) Pub. No.: US 2006/0168017 A1
(43) Pub. Date: Jul. 27, 2006

(54) Dynamic spam trap accounts

(75) Inventors: Pablo M. Stern, San Francisco, CA (US); Arnold D. de Leon, Cupertino, CA (US); Eliot C. Gillum, Los Gatos, CA (US); Jacob D. Brutlag, Mountain View, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/000,623

(22) Filed: Nov. 30, 2004

(51) Int. Cl. G06F 15/16

(52) U.S. Cl. 709/206

(57) ABSTRACT

A system and method for gathering data on unsolicited email messages delivered to non-existent accounts. The method may include the steps of receiving email for a subset of non-existent email recipient accounts on an email system; and gathering message data for at least a subset of said invalid recipient accounts. The system may include a messaging transfer agent; a dynamic trap engine; and a dynamic trap message data store.

### BACKGROUND OF THE INVENTION

1. Field of the Invention

The present invention is directed to fighting spam.

2. Description of the Related Art

With the extensive use of email now sent on the Internet, unsolicited email or “spam” has become a major problem for Internet users. To combat this problem, spam filters have been implemented at various parts of the message delivery path. Spam filters can be run by users when incorporated into their email user agent (MUA), enterprises when incorporated into or operated in conjunction with a message transfer agent (MTA), Internet Service Providers and other email domains such as Web-email providers.

A spam filter is a program that is used to detect unsolicited and unwanted messages and prevent those messages from getting to a user's inbox. A spam filter looks for certain criteria on which it bases judgments on whether a message is spam or not. The simplest spam filters watch for particular words in the subject line of messages and prevent messages containing these words from reaching a user's inbox. This method is not especially effective, too often filtering legitimate messages (known as false positives) and letting actual spam through (known as false negatives). An extension of these simple filters matches different components of the message to known spam. This may include message headers or contents in the body of the message. Another method for identifying spam involves taking a digital signature of the message and comparing it to digital signatures of known spam. Other programs, such as those based on naïve-Bayesian filters or other heuristic filters, attempt to identify spam through suspicious word patterns or word frequency. These filters look for suspicious sets of message attributes that include, in part, word patterns and word frequency as well as suspicious header fields, spoofed return addresses, and the like. Current-generation filters often rely on a combination of these methods.

The most simplistic spammers send hundreds, thousands, or millions of messages to random addresses in the hopes that a fraction of those addresses are active. The spammer will use a software program to conjure possible names and guess at email addresses based on the names. If a failure response is not returned to them during the message transmission process, the spammer assumes that the address is probably valid. These lists generally contain a large number of nonexistent recipients, not unrelated to the fact that the recipients don't actually want to be on the list. Other techniques include the use of dirty recipient lists. A list becomes dirty when un-permitted email addresses are added to a strictly opt-in list. This most often occurs through improper business practices or faulty list management.

A namespace miner is similar to a spammer, but their goal is to generate a list of valid accounts in a domain to eventually sell to spammers for profit. The distinction between spammers and namespace miners is that the latter generally does not send email message but simply collects data about the recipient existence.

A common mechanism used to catch spam is by finding similarities in known spam messages, often retrieved from “fake” user accounts known as “traps”. Traps can be effective but are generally static and thus do not change over time. Because the exact account names must be discovered, shared, and finally used by the spammers, static trap accounts have limited effectiveness. They are also subject to avoidance by spammers if the spammers discover the traps that are causing their spam to be filtered.

Hence, systems and methods for reducing spam by detecting characteristics of spam are of great value.

### SUMMARY OF THE INVENTION

In one aspect, the invention is a method for gathering data on unsolicited email messages. The method may include the steps of receiving email for a set of non-existent email recipient accounts on an email system; and gathering metadata and/or messages for at least a subset of said invalid recipient accounts. In one aspect, the subset is an unbounded set. The method may include additional steps, wherein the step of gathering includes accepting a message for a non-existent email recipient; and storing message data.

In another embodiment, the invention is an email system including a number of recipient accounts. The email system including a messaging transfer agent; a dynamic trap engine; and a dynamic trap message data store.

In a further embodiment, the invention is a computer-readable medium having computer-executable instructions for performing steps. In one aspect, the steps may comprise: receiving email for a subset of non-existent email recipient accounts on an email system; determining whether to accept a message to ones of said non-existent email recipients comprising a subset of said non-existent email recipients; based on said step of determining, accepting messages for said subset; and storing accepted data messages.

In another embodiment, the invention is a method operating on an email system. The method may include the steps of: receiving the request to send email to a non-existent email recipient; hashing the non-existent email recipient; determining whether to accept the email based on a comparison of the results of said hashing step to a test bucket; if said step of determining results in accepting the email, storing the email in a data store and issuing a non-delivery receipt to a sender; and if said step of determining results in rejecting the email, discarding the email.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 depicts a block diagram of computer hardware suitable for implementing the invention.

FIG. 2A is a block diagram of a conventional spam email dictionary attack and response.

FIG. 2B is a block diagram of the response by the system of the present invention to a dictionary attack.

FIG. 3 is a flowchart of one embodiment of the method of the present invention.

FIG. 4 is a flowchart of a further embodiment of the present invention for determining whether to issue a dynamic trap account.

FIG. 5 is a block diagram illustrating one embodiment of the system of the present invention.

FIG. 6 is a block diagram illustrating an alternative embodiment of the system of the present invention.

FIG. 7 is a flowchart illustrating a further method in accordance with the present invention for modifying the dynamic trap account algorithm.

### DETAILED DESCRIPTION

In accordance with the invention, dynamic trap accounts (DTAs) are used to gather data about unsolicited messages. In one embodiment, unsolicited email to non-existent accounts is gathered for use in assessing patterns of unsolicited emails and improving the effectiveness of systems used to defeat unsolicited emails. Non-delivery receipts are provided for such non-existent accounts in order to allow innocent users to correct innocent misspellings of an email address, and opt-in marketing lists to clean “dirty” lists. The method of the invention may be performed on one or more general computing systems, and a system in accordance with the invention may comprise an email server including at least one messaging transfer agent, or a web-based email service including a number of email servers and transfer agents. The system of the present invention targets both entities in the same manner.

In one aspect, the system and method of the present invention may be configured or performed by a system administrator controlling aspects of the destination email system. In one embodiment, the service administrator may be a person or a machine, such as a computer or a process running on a computer.

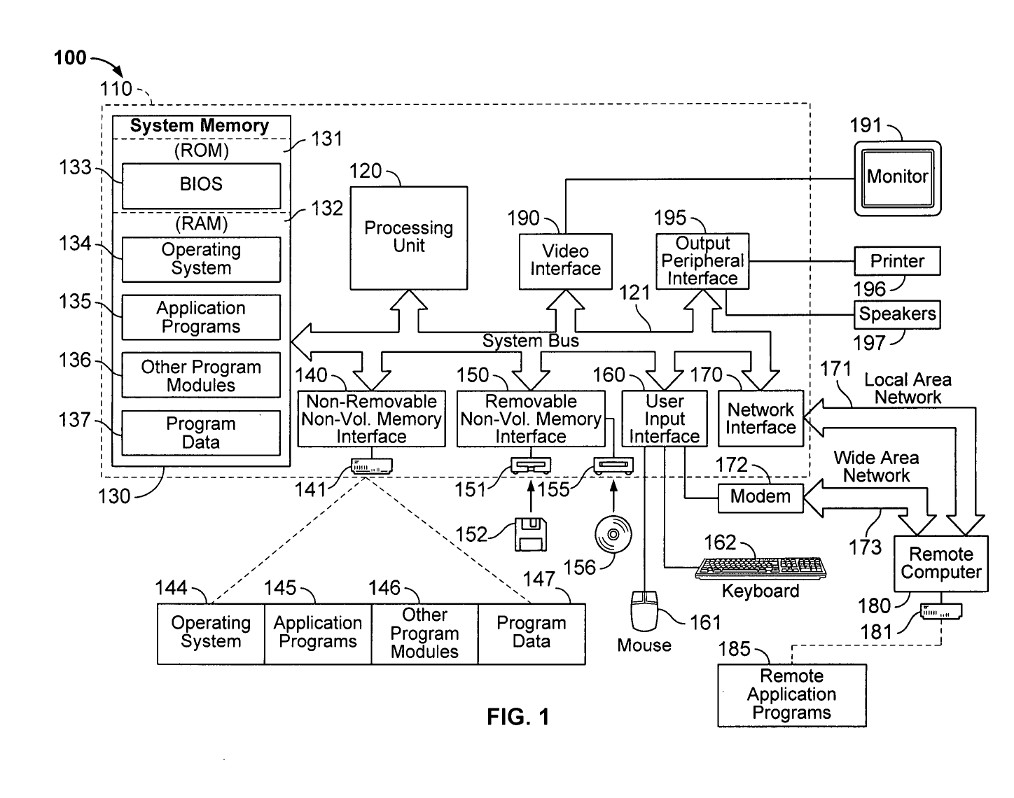

FIG. 1 illustrates an example of a suitable general computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

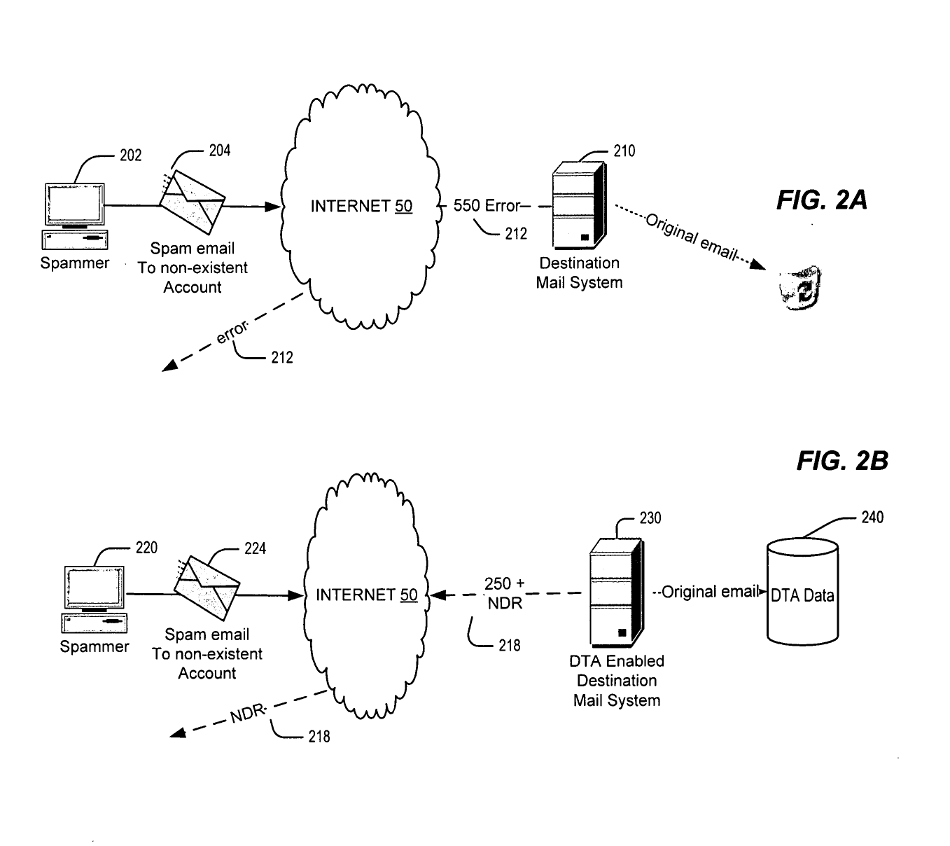

FIG. 2A illustrates the typical transaction between a spammer conducting a dictionary attack against a destination email system 210. A spammer will send a set of emails 204 to a number of accounts on a destination email system 210, hoping one of the messages will reach a true account. The majority of emails, like email 204, will be addressed to non-existent accounts. For example, the spammer may try any of a number of variations of an email account name associated with the domain address of the destination system, such as bob1@example.com, bob2@example.com, . . . bob100@example.com. Each message 204 will be transmitted by a network, or a combination of public and private networks such as Internet 50, to the destination email system 210. Email systems use the SMTP protocol, in accordance with IETF RFC 2821, to send messages over the Internet from one server to another. In SMTP, the spammer's message transfer agent (MTA) identifies itself, provides a purported sender's email address, provides a list of recipients on the destination email server 210, and provides the contents of the email. For each recipient, the receiving email server 210 usually provides a protocol level response indicating if the user is able to receive email. When a user exists on destination email server 210, the receiving email server responds with an “SMTP okay” (message “250”) response; if the user does not exist, generally a permanent error (“550”) response is returned. The SMTP protocol also allows for a delivery status notification (DSN) in the event that the user is accepted during the protocol but the delivery subsequently fails. In this event, an email message is delivered back to the purported sender's email address with a failure notification. This email notification is a non-deliverable response (NDR) in accordance with IETF RFC 1894, An Extensible Message Format for Delivery Status Notifications.

In SMTP, the email account name is provided in the RCPT TO: command. Upon receipt, the destination email system may determine if the account identified in the RCPT TO: command is a valid account on the system 210. If the recipient is not valid the destination email system will normally issue a permanent error, and the source system may choose to proceed with delivery to other recipients or abort the pending mail transfer transaction. The destination system may also accept the message from the sending system and then at a later time issue a NDR for a recipient that is invalid.

FIG. 2B shows the effect of a dictionary attack utilizing the system of the present invention. In FIG. 2B, when spam 224 to a non-existent email account 224 is sent to a dynamic trap account (DTA) enabled destination email system 230 in accordance with the present invention, the DTA enabled destination email system 230 will, for all or a limited number of non-existent accounts, issue a SMPT OK (250) response, store the message in a DTA spam data store 240, and generate an NDR to the original sender 220. Unlike static trap accounts, the system of the present invention uses accounts that have not been previously provisioned. The invention provides mechanisms for determining whether to respond if a non-existing account “exists” are discussed below. However, the number of dynamic trap accounts which may be provided is essentially unbounded.

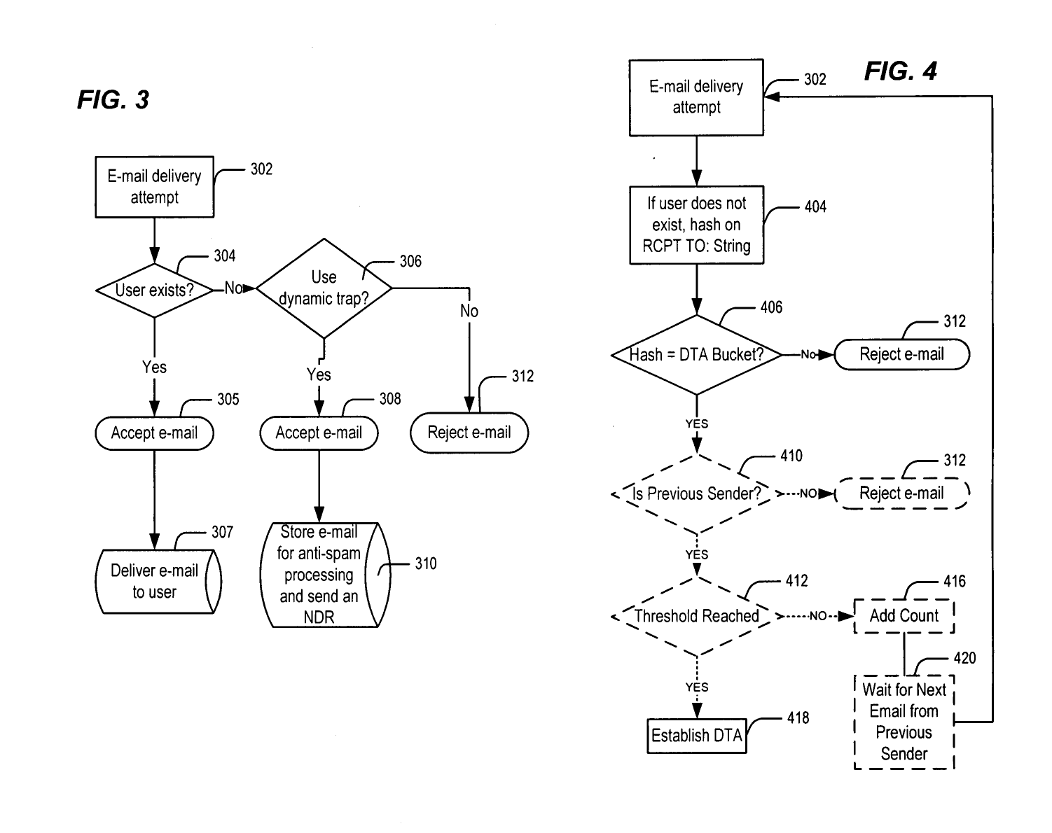

FIG. 3 is a flowchart of one embodiment of the method of the present invention. At step 302, an email delivery attempt for a spammer to a destination email system will be made. At step 304, the destination email system will determine whether the user exists. If the user does exist at step 305, the email will be accepted and delivered to the user at step 307. At step 307, the email may be subject to spam filtering prior to delivery. If the user does not exist at step 304, then a decision will be made at step 306 as to whether or not the recipient address will be used as a dynamic trap account.

There are a number of ways the decision at step 306 may be made. One embodiment of the invention includes accepting all email for non-existent accounts as dynamic trap accounts. Another embodiment of the method for deciding whether to issue a dynamic trap account is set forth below with respect to FIG. 4.

If a dynamic trap account is issued, at step 308 the email will be accepted and at step 310, the email message and associated header data stored for later anti-spam processing. An NDR will also be sent at step 310. If the dynamic trap decision at step 306 is negative, the email will be rejected at step 312 and an NDR may be sent or an SMTP protocol level failure (550) may be issued.

The sending of a non-delivery receipt back to the original sender is performed to ensure that legitimate senders, who simply happen to mistype an address into the address line of an email, are able to correct their mistake. Legitimate bulk mailers use feedback from standard methods in order to clean their email list. Such standard methods include those which are based on protocol level 550 responses, subsequent non-delivery receipts, or by sending periodic re-opt-in requests to users on the list. Legitimate email marketing lists may become “dirty” email lists over time, this may occur as users vacate old email accounts. In the context of the present invention, such senders will have the opportunity to rectify problems with their list by cleaning their list in response to the NDR. In the context of the present invention, the sending of an NDR, rather than a protocol 550 response, may be governed by a set of rules such as the number of NDRs sent to a given purported sender or domain. Information from other methods like Sender ID, SPF or DomainKeys may also be used to control the decision on whether to send an NDR or not.

An NDR is of no benefit for spammers, because spammers do not generally provide legitimate reply addresses or opt-out links for the sender of an email. A dictionary attack uses protocol 550 responses to determine whether emails are valid of a particular domain. Thus, if the email is from a spammer, NDRs for spam will be delivered into the non-existent account, or as is often the case, to an unsuspecting email account of the user that was spoofed. Hence, the NDR 218 which is returned to the spammer 220, in FIG. 2, will essentially be lost. Even if a spammer uses a legitimate sending address and processes the NDRs they will only be able to stop using the DTAs that they have discovered, there will still be an infinite number of DTAs that they will fall in.

As noted above, a number of methods exist for determining whether to issue a dynamic trap account for a non-existent email account. In one embodiment, step 306 can comprise implementing dynamic trap accounts to accept email for all non-existent accounts. While such embodiment would provide a significant amount of data, bandwidth restrictions may lead system administrators to desire to limit such uses of dynamic trap accounts.

FIG. 4 illustrates one method of determining whether to issue a dynamic trap set forth at step 306. The method of FIG. 4 implements a hash function to determine whether or not to issue dynamic trap account. In general, for each attempted delivery to a recipient of a non-existent account, a hash of the account name in the RCPT TO: command is performed. If the hash falls into a pre-determined bucket, a DTA process is initiated and the email is accepted.

In FIG. 4, step 302, upon an email delivery attempt 302, if the account does not exist, a hash will be performed on the RCPT TO: string at step 404. At step 406, a decision is made as to whether the hashed string falls into the DTA bucket. The system administrator may apportion certain types of receipt to addresses as being those for which the hashes will require generation of a dynamic trap account. One simple example is to limit the number of trap accounts to a low percentage of the namespace, for example 1% or 5%. Using a hash ensures that although a limited number of accounts will be used, the naming convention of which accounts are used for DTAs will appear random. The advantage of using hash is that the same account will always generate the same response, so that there is no inconsistency on the account existing one time and not existing another time. Any number of alternative mechanisms for selecting which accounts will generate DTAs may be used. For example, a basic approach to limit all dynamic trap accounts to non-existent user accounts beginning with the letter A.

If the hash does not fall into the dynamic trap account bucket, then at step 408 the email would be rejected in a manner similar to that set forth with respect to FIG. 2A. If the hash does fall into the DTA bucket at step 406, then a DTA may be established at step 418.

In one embodiment, the hash function may be a simple random number fixed length hash function. In other embodiments, the hash function may comprise more complex hashing functions using a secret key. Use of a keyed hash would provide additional security to the DTA system by ensuring that spammers could not reverse engineer more simplistic hash functions to determine which accounts are dynamic trap accounts to be avoided.

Two optional steps, steps 410 and 412—indicated in phantom in FIG. 4—may also be implemented. In one embodiment, the decision for determining whether to issue a DTA may be modified to prevent issuing DTAs for senders who do not reach a specific volume of emails. Steps 410 and 412 allow the system administrator to inject additional choices into whether or not to establish a dynamic trap account at step 418. At step 410, the system administrator may have decided to only establish dynamic trap accounts after the number of emails from a particular sender has reached a specific threshold. In this context, the system first checks whether the sender has previously sent emails at step 410. If not, the system can simply reject the email at step 312.

If the sender is a previous sender, then a check is made to determine whether a threshold number of previous emails have been received by the sender at step 412. In one embodiment, the “sender” is usually identified by an IP address (i.e. the IP of the host connecting to the receiving mail transfer agent.) Other methods of identifying a sender such as Sender ID may also be utilized. If not, at step 412, a count will be added to the number of emails that the previous sender has forwarded at step 416. If the threshold has been reached at step 412, then the dynamic trap account is utilized at step 418. Because an email system may not want to generate dynamic traps to low volume senders, this threshold can be used for eligibility to receive a dynamic trap. Once a threshold is reached, the receiving end will periodically issue a “valid recipient” response (250) for an invalid recipient.

It should be recognized that while steps 410 and 412 are shown as implemented after the hash function at step 406, in alternative embodiments of the invention, the determination of a sender threshold may occur at different points in the DTA decision process, such as before step 404. In another alternative, DTAs can be issued simply based on steps 410 and 412, without performing steps 404 and 406. In such embodiment, DTAs can be issued (at step 306) simply based on the frequency of receipt of spam from a particular sender.

Another alternative to step 306 involves using random responses. In this alternative, step 306 can be assigned on a truly random basis. The frequency of the DTA responses can be dictated by a variable. When the variable dictates that the given recipient request should be issued a dynamic trap account, the sender will then be allowed to complete the recipient look-ups for the message and deliver the email to the recipient that did not otherwise exist. The receiving system will deliver the message to all legitimate recipients. In accordance with the aforementioned description, the message for the invalid recipient will be recorded but an NDR will be forwarded back to the sender. One issue with using random responses is that consistency over time for dynamic trap accounts may become transient. For example, an account that exists at a certain point and time may not exist in a future look-up.

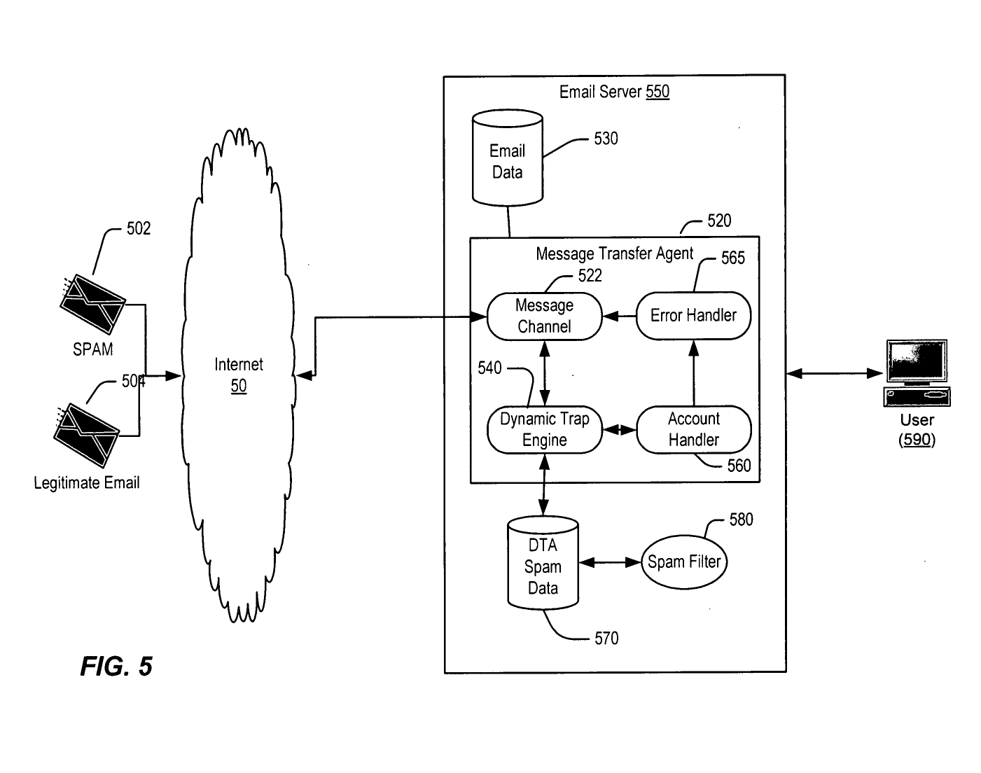

As noted above, one system for implementing the present invention may include an email server. FIG. 5 illustrates one embodiment in an email server 550 for implementing the method of the present invention. Email server 550 may comprise a computing system such as that shown and described with respect to FIG. 1. In FIG. 5, to emails, one spam 502 and one legitimate 504, are transmitted via Internet 50 to email server 550. Email server 550 includes a message transfer agent 520 which may, for example, include a message channel 522, a dynamic trap engine 540, and an account handler 560. The MTA is responsible for receiving incoming emails and delivering the messages to individual users other MTAs. The MTA is commonly referred to as the email server program. Sendmail and Microsoft Exchange Server are two examples of MTAs. The MTA includes one or more message channels 522, which may include one or more local delivery channels and handlers, each of which use a specific protocol such as SMTP to transfer the messages which may be defined per IETF RFC 2822—Internet Message Format. Messages leaving a local host computer 590 are sent to other MTAs through the message channel via Internet 50. Local email and incoming messages for user's local accounts may be delivered by the local delivery channel. Handlers help route messages. Usually, incoming messages are sent to the account handler 560 which determines to whom the message should be delivered. The account handler 560 can also route the message to an error handler 565 which generates the aforementioned error messages. Legitimate messages from email server 550 are provided to users 590 via the messaging channel 522.

Email server 550 also includes email data 530, a DTA spam data store 570, and a spam filter 580. In one embodiment, the methods described in accordance with the discussion of FIGS. 2B, 3, 4, and 7 are performed by the dynamic trap engine 540. Data from DTA accounts, gathered by the DTA trap engine, is stored in the DTA data store 570 and is consumed by the spam filter or spam filter training system 580 to further optimize filters which are searching for spam receipt through the message channel 522.

In accordance with the previous description, once the dynamic trap engine 540 has determined that a dynamic trap should be issued and the email stored, the email data can be stored in the DTA spam data store 570. Account handler 560 determines whether or not the RCPT TO address provided with the message 502 is in fact a legitimate account on the email server 550.

Data in the DTA spam database 570 can be utilized by a number of different types of spam filters 580. Such spam filters may include, but are not limited to, Bayesian-style training systems, hash (or fuzzy hash) style filter creation, safelists, blacklists, and other types of filters. The data may also be used for reputation establishment for the sender, or a weighting algorithm which feeds into an established reputation for the sender. These latter techniques may be used with sender authentication techniques, as described below.

Normally, during the lifetime of an email system, accounts which exist may expire or be deleted over time. Some system administrators maintain a history of all once valid accounts. Unlike static trap accounts, DTAs may not have a definitive history having been legitimate accounts in the past. If a system administrator maintains such a history, one can use this history and draw a correlation between such accounts and those that are used as dynamic trap accounts. If a sender is consistently hitting accounts that never existed, it is more likely that the sender is a spammer. If an email comes in from a particular sender to accounts that did exist, it is less likely that they are spammers. In another example is to draw similarities between the account names being established as DTAs and those which are current or previous existing legitimate accounts. In this scenario, a DTA may only be issued for accounts that have never existed in the lifetime of the email system, thus increasing the likelihood that a DTA is generated to a spammer.

In utilizing the data stored in DTA data store 570, corroborating evidence of the accuracy of such data may be provided. Methods to couple dynamic trap accounts include incorporating dynamic trap data into static trap data, incorporating dynamic trap data into user-submitted spam examples, user-identified spam messages, or incorporating dynamic trap data before other dynamic trap data.

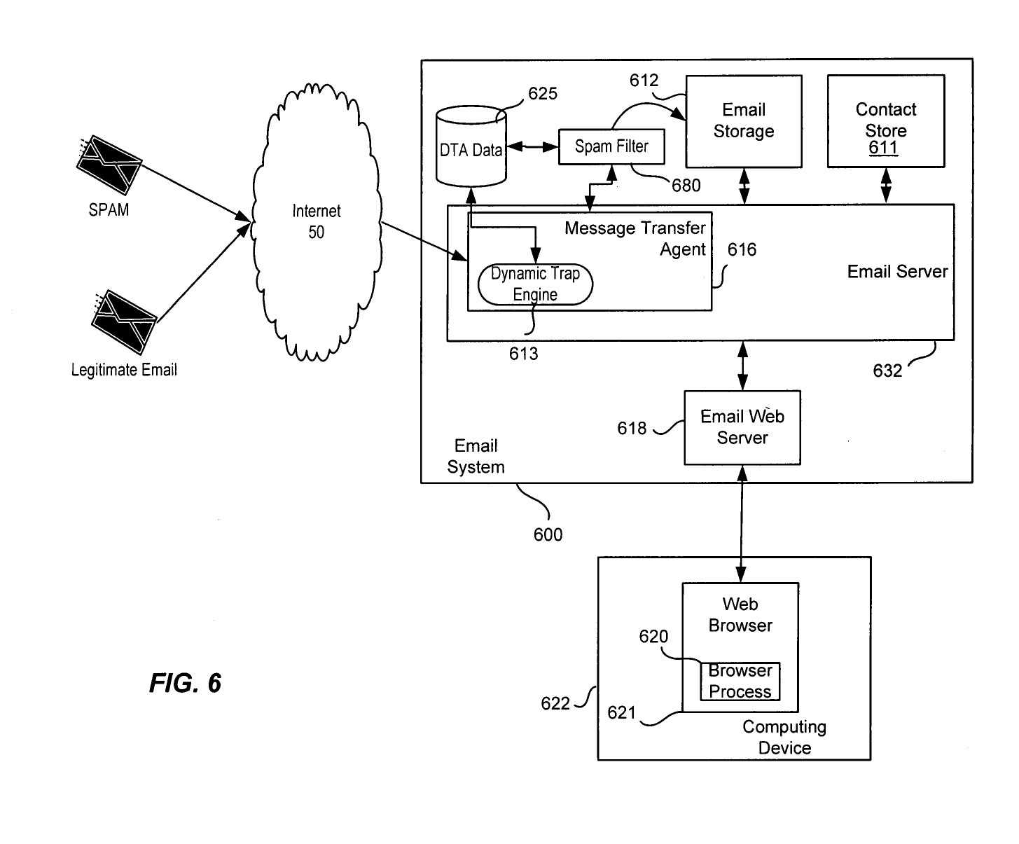

In the embodiment of FIG. 5, a single email server 550 is shown. A common form of email provided on the Internet today is a web-based email service. FIG. 6 illustrates one embodiment of a system 600 for providing a web email service utilizing the present invention.

System 600 includes a contact store 611, email storage 612, one or more email servers 632 including an MTA 613, a dynamic trap engine 613 integrated with MTA 616, and email web server 618. Users connect to email system 600 by means of a computing device 622, which may include a local email client (not shown) or a web browser 621 implementing a browser process 620 which displays an email interface on the computing device. In one embodiment, there may be a plurality of computer devices 622 (not shown) in communication with system 600.

The email system interacts with web browser 620 to provide interface pages that implement a web-based email service on one or more computing devices 622. In the system of FIG. 6, contact store 611 stores user account information. User information can include account information, as well as telephone, email, address, user contact lists (e.g., address book, email contact lists, messenger contact lists (or buddy lists), email service lists, and other lists), and other information. Email storage 612 includes data storage devices that store email content. Email server 632 provides email data to email web server 618, and sends data to and receives data from contact store 611. Email web server 618 provides the network page data hyper text markup language (HTML) code or other browser rendering technologies. Email server 618 also loads the browser process 620 into the web browser 621, and sends script instructions, such as JavaScript, to the browser process 620 to implement the web-based email service.

MTA 616 may include one or more message channels, error handlers, and routing handlers (not shown) to allow MTA 616 to receive emails for users in the particular domain serviced by system 600. In accordance with the invention, dynamic trap engine 613 implements dynamic trap accounts across the domain served by email system 600. Data gathered by the dynamic trap engine 613 may be stored in a system-wide DTA data store and used to train system-wide spam filters 680. In this context, the data gathered in DTA data store 625 may be utilized internally by the email system 600, or may be provided to one or more agents outside the system who provide spam filtering services. One example of such a service is Symantec Brightmail AntiSpam.

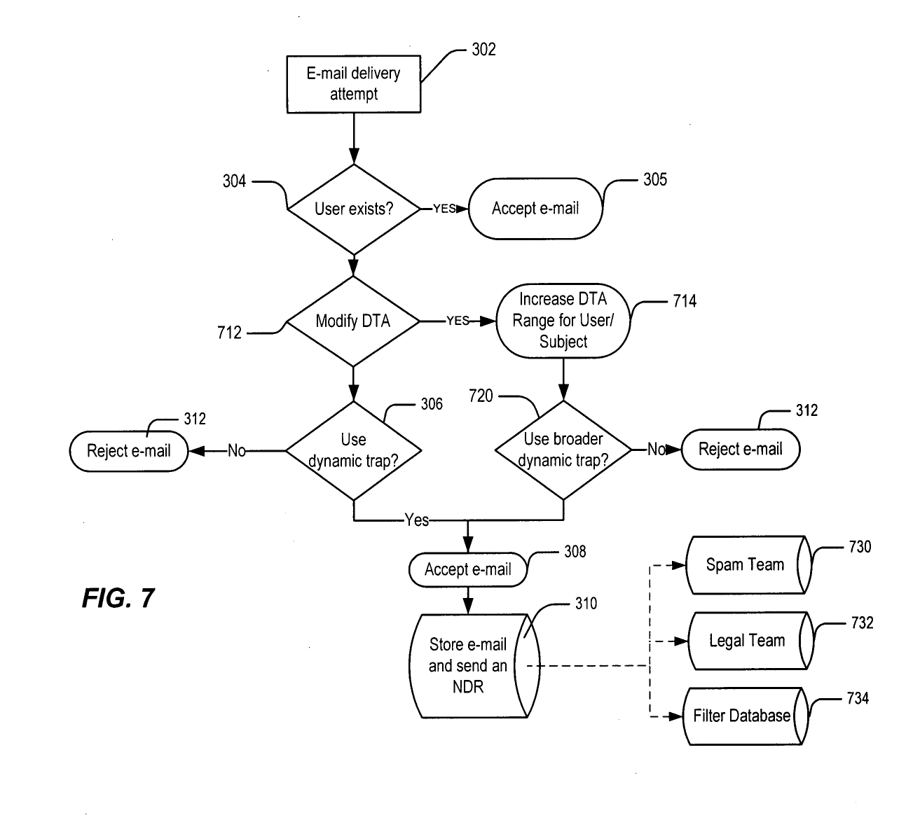

Yet another alternative of the method of the present invention, the decision of whether to establish a DTA can be tuned using feedback from data gathered by other criteria. FIG. 7 illustrates an alternative embodiment of the method of the present invention showing how feedback from existing other criteria can be used to modify whether to use additional, more focused DTAs. Elements of the method of FIG. 7 previously described with respect of FIG. 3 are commonly numbered.

At an email delivery attempt step 302, if a user exists at step 304, then the email is accepted at step 305 and delivered to the user at step 307. If the user does not exist, then the system checks to determine at step 712 whether or not to modify the dynamic trap account creation algorithm. Such decision may include any number of algorithms. The difference between rates of invalid recipient requests and that of actual email bound request recipients, essentially the rate of dictionary harvesting attacks, is the rate of real world tuning. Examining a histogram of valid/invalid recipient ratios a general idea of traffic pattern can be established. This may be then correlated to determine “who” falls into spikes in the histogram. Ultimately, the likelihood of responding with a DTA can be established, and at step 714, the DTA range (corresponding to whether to issue a DTA in step 306) can be expanded based on some criteria, such as the user, originating IP, originating domain, or other factors. Once this range is expanded, the broader dynamic trap algorithm can be used at step 720, and emails for the modified DTA accounts stored in the DTA data store step 310.

FIG. 7 shows optional steps of routing information provided by the standard or modified DTA algorithms to different users. In certain cases, information from the dynamic trap accounts can be used for more than just spam fighting. For example, the information may be used by a spam team in development or by a legal team in pursuing action against spammers. Information from the data store can be routed to each team as shown in FIG. 7. In one embodiment, the decision about which information to route to each team can be made by allocating ranges of the hash buckets to each team. For example, one may decide to provide a percentage of all emails subject to the DTA algorithm to each team. In the example shown in FIG. 7, for example, the DTA algorithm may collect 10 percent of all emails to non-existent accounts, routing 1 percent to a legal team 732, 2 percent to a filter database 734 and 7 percent to a spam development team 730.

It will be further recognized that dynamic trap accounts may be integrated with sender verification protocols such as Sender ID and Sender Policy Framework (SPF).

When DTA information is integrated with the aforementioned technologies, such information can be used to gauge the reputation of a particular sender. If the sender has published their sender verification information using Sender ID, dynamic trap accounts can be used as an input to the systems to determine how well a particular mailing entity behaves. Trap data can be parsed and incorporated into a sender's reputation adding a negative weight to their “trustworthiness”. DTAs are useful at reducing the impact of spoofing on a sending IP reputation because they avoid the recipient induced false-negatives associated with IP-based authentication schemes because no real recipient exists to set up such a thing. Obviously a non-spoofed sender who hits lots of DTAs isn't a good sender, but since a good sender with sufficient volume will occasionally hit DTAs (because of user errors in typing in addresses, account expirations, etc), this data can still be used to infer a positive data point about whether the spoofing “detected” in mail to real users is related to recipient-related forwarding.

DTA information may also be combined with information provided by static trap accounts running on the same system, or with user reported spam. A comparison of DTA information with static trap account information could be used to expand data gathering from spammers appearing in both data sets, or for other purposes. Likewise, many email systems now allow users to report individual messages as spam and use such data to modify their spam filters to increase the filters' accuracy. DTA information can be used in conjunction with user reported spam to develop correlations on the accuracy of DTA information which is used to modify spam filters. Any differences between user reported spam and the DTA data can be taken into account in the spam filtering system.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for gathering data on email messages sent to non-existent accounts, comprising:
receiving email for a set of non-existent email recipient accounts on an email system; and
gathering message data for at least a subset of said invalid recipient accounts.

2. The method of claim 1 wherein the subset is an unbounded set.

3. The method of claim 1 wherein the step of gathering comprises:
accepting a message for a non-existent email recipient; and
storing message data.

4. The method of claim 3 further including the step, prior to said step of accepting, of determining whether to accept a message for a non-existent email recipient.

5. The method of claim 4 wherein the step of determining includes using hashes to generate a subset of non-existent accounts.

6. The method of claim 5 wherein the step of hashing includes a technology which makes the results of the hash unpredictable to an observer.

7. The method of claim 6 wherein the step of hashing uses a keyed hash.

8. The method of claim 3 wherein the step of determining includes using a random list of recipients.

9. The method of claim 3 wherein the step of determining includes using all non-existent accounts.

10. The method of claim 3 wherein said step of determining includes establishing minimum threshold for a characteristic of the message.

11. The method of claim 10 wherein the threshold is the number of messages received from a sender.

12. The method of claim 1 further including the step of:
associating the message data from said subset of said invalid recipient accounts with sender verification systems.

13. The method of claim 1 further including the step of:
providing said message data from said subset of said invalid recipient accounts to a spam filtering system.

14. The method of claim 13 further including the step of modifying an algorithm or input data in the spam filtering system.

15. The method of claim 1 further including the steps of:
providing a plurality of static trap accounts;
gathering message data from messages addressed to said static trap accounts; and
comparing message data from said subset of said invalid recipient accounts with said message data from messages addressed to said static trap accounts.

16. The method of claim 1 wherein the step of receiving includes the step of:
generating a non-delivery report addressed to a sender of an email.

17. The method of claim 1 further including the step, prior to said step of gathering, of determining whether to accept an email for a non-existent email account based on evaluating a characteristic of email data sent to at least one of said non-existent email accounts.

18. The method of claim 17 wherein said step of determining comprises accepting a message based on said characteristic.

19. The method of claim 17 wherein said characteristic is the sender address and the frequency of email from said sender address.

20. An email system including a number of recipient accounts, comprising:
a messaging transfer agent;
a dynamic trap engine; and
a dynamic trap message data store.

21. The email system of claim 20 wherein the dynamic trap message data store includes multiple dynamic trap message data stores.

22. The email system of claim 20 wherein the dynamic trap message data store includes message data for at least a subset of non-existent recipient accounts.

23. The system of claim 20 wherein the subset is all of said non-existent accounts.

24. The system of claim 22 wherein the subset is based on the frequency of receipt of message data from a sender email address.

25. The system of claim 22 wherein the subset is based on the frequency of receipt of message data from a sender IP address.

26. The email system of claim 20 wherein the dynamic trap engine includes code for determining whether to instruct the messaging transfer agent to accept a message for a non-existent account.

27. The email system of claim 20 further including a spam filter accessing the dynamic trap message data store and filtering spam based on data in said dynamic trap message data store.

28. The email system of claim 20 wherein the email system comprises an email server.

29. The email system of claim 20 wherein the email system comprises a plurality of email servers including a plurality of messaging transfer agents.

30. The email system of claim 29 wherein each of said plurality of messaging transfer agents includes a dynamic trap engine, and the output of each said engine are provided to the dynamic message trap data store.

31. The email system of claim 20 wherein said message transfer agent includes said dynamic trap engine.

32. A computer-readable medium having computer-executable instructions for performing steps comprising:
receiving email for a set of non-existent email recipient accounts on an email system;
determining whether to accept a message to ones of said non-existent email recipients comprising a subset of said non-existent email recipients;
based on said step of determining, accepting messages for said subset; and
storing accepted data messages.

33. The computer-readable medium of claim 32 having further computer-executable instructions for performing the step of generating a non-delivery receipt for said accepted messages.

34. The computer-readable medium of claim 32 having further computer-executable instructions for performing the step of using hashes to generate the subset of non-existent accounts.

35. The computer-readable medium of claim 32 having further computer-executable instructions for using a keyed hash.

36. The computer-readable medium of claim 32 having further computer-executable instructions for performing the step of modifying a spam filter based on said the message data from said subset.

37. The computer-readable medium of claim 32 having further computer-executable instructions for performing the steps of:
providing a plurality of static trap accounts;
gathering message data from messages addressed to said static trap accounts; and
comparing message data from said subset of with said message data from messages addressed to said static trap accounts.

38. The computer-readable medium of claim 32 having further computer-executable instructions for performing the step of determining a characteristic of message data sent to at least one of said non-existent email accounts and wherein said step of determining comprises accepting a message based on said characteristic.

39. A method for operating an email server, comprising:
receiving an email for a non-existent email recipient;
hashing the non-existent email recipient;
determining whether to accept the email based on a comparison of the results of said hashing step to a test bucket;
if said step of determining results in accepting the email, storing the email in a data store and issuing a non-delivery receipt to a sender; and
if said step of determining results in rejecting the email, discarding the email.

40. The method of claim 39 wherein if said step of determining results in rejecting the email, an indication such email was rejected is stored in a data store.
